(19) United States
(12) Patent Application Publication
(10) Pub. No.: US 2024/0103489 A1
(43) Pub. Date: Mar. 28, 2024

(54) OPTIMIZED TOOL PATH ALGORITHM IN MANUFACTURING SYSTEMS AND METHODS

(71) Applicant: Xavier and Rubina Bedford, Lions Bay (CA)

(72) Inventor: Xavier Bedford, Lions Bay (CA)

(21) Appl. No.: 18/372,024

(22) Filed: Sep. 22, 2023

Related U.S. Application Data
(60) Provisional application No. 63/409,403, filed on Sep. 23, 2022.

(51) Int. Cl. G05B 19/4099

(52) U.S. Cl. CPC G05B 19/4099; G05B 2219/49023

(57) ABSTRACT

Some examples include a 3D printing, incremental sheet forming, and incremental formation CNC manufacturing system utilizing an optimized approach to place a non-intersecting Eulerian curve on a set of nodes that are constrained by a boundary curve. An input matrix is partitioned into subsets and solves these subsets individually and then combines the solution. A minimum spanning tree (MST) is created from dispatched nodes inside the shape outline. While creating an MST, the method enables the system to use input data with weights to give desired geometry properties. An output instruction is generated for fabrication tools utilizing a variety of manufacturing methodologies such as single point manufacturing, incremental formation manufacturing, and additive manufacturing, including 3D printing.

### CLAIM OF PRIORITY

This patent application claims the benefit of priority, under 35 U.S.C. Section 119(e), to Bedford et al, U.S. Provisional Patent Application Ser. No. 63/409,403, entitled “OPTIMIZED TOOL PATH ALGORITHM IN MANUFACTURING SYSTEMS AND METHODS,” filed on Sep. 23, 2022, which is hereby incorporated by reference herein in its entirety.

### BACKGROUND

Single point manufacturing and additive manufacturing are processes that utilize computer implemented algorithms to create products without a pre-set cast or tool. In recent years, new toolless and incremental manufacturing methods and systems have been developed, but there remains a need for a program to optimize the different methods that rely on similar principles.

### SUMMARY

The following summary is provided to introduce a selection of concepts in a simplified form that are further described below in the detailed description. This summary is not intended to identify key features or essential features of the claimed subject matter, nor is it intended to be used to limit the scope of the claimed subject matter.

Single point manufacturing is a process that utilizes algorithms or methodology that enable a fabrication tool to shape a product without a pre-set or pre-shaped cast or tool. Normally, manufacturing processes utilize a mold, die-cast, or other similar equipment to determine the shape of the end product. Single point manufacturing circumvents the need to produce such molds/diecasts by enabling the fabrication tool to shape the products directly. This can be achieved by incremental sheet forming on an existing workspace, or through materialization as in 3D printing. In any of the discipline of the single point manufacturing, the algorithm and methodology to be implemented would determine the quality and shape of the final product.

Generally, the algorithm is directed to a solution to the traveling salesman problem, whereby all points are visited in the shortest amount of time. In single point manufacturing, the tool path is freely driven, and not guided in a preset fashion as in injection molding or die cast manufacturing. As such, an important aspect is the tool path formation. The complexity of the final product determines the level of calculation required to obtain the tool path. The more efficient the algorithm is, the more elaborate formations can be generated through the single point manufacturing process,

The algorithm is a theoretically optimized approach to place a non-intersecting Eulerian curve on a set of nodes that can be constrained by a boundary curve. The problem involves visiting all points whilst not overlapping on oneself and staying as short as possible. Due to the nature of curves, following the perimeter of a face (or closed looped geometry) will always be the fastest way to visit all points, due to backtracking. This is similar to all traveling salesman problems that require end point and start point be the same point. The disclosed method includes multiple methods that comprises varying degrees of backtracking.

In some examples, the disclosed method takes an outline shape, creates an offset geometry based on a minimum spanning tree of a node matrix, performs Boolean operations, and outputs an optimized tool path, An optimized tool path algorithm takes a unique approach of using a minimum spanning tree on a node matrix constrained by the outline shape to generate an offset geometry. This allows the algorithm to calculate efficiently an optimal path that minimizes unnecessary motions and backtracking.

Prior art in tool path optimization often relies on following a perimeter or using preset patterns. Some examples of this disclosure do not require a preset path and can dynamically calculate optimized paths for any arbitrary outline shape.

Another aspect includes the ability to incorporate user-defined input weights to control characteristics like texture. This allows unique customization and optimization for the specific manufacturing requirements.

Another advantage over prior art is the flexibility to output instructions for various manufacturing methods like 3D printing, CNC machining, and so forth. Rather than being limited to a single process, this disclosure provides a generalized approach to tool path optimization across different technologies. The use of minimum spanning trees on node matrices, incorporation of input weights, and flexibility across manufacturing methods are convenient aspects over prior optimization techniques.

These and other features and advantages will be apparent from a reading of the following detailed description and a review of the appended drawings. It is to be understood that the foregoing summary, the following detailed description, and the appended drawings are explanatory only and are not restrictive of various aspects as claimed.

### BRIEF DESCRIPTION OF THE DRAWINGS

FIG. 1 illustrates an example embodiment of the optimized tool path system.

FIG. 2 illustrates an example embodiment of the algorithm implemented in the optimized tool path system.

FIGS. 3A-3B illustrate an example second embodiment of the algorithm implemented in the optimized tool path system.

FIG. 4 illustrates an example third embodiment of the algorithm implemented in the optimized tool path system.

FIG. 5 illustrates an example fourth embodiment of the algorithm implemented in the optimized tool path system.

FIG. 6 illustrates an example fifth embodiment of the algorithm implemented in the optimized tool path system.

FIG. 7 illustrates an example sixth embodiment of the algorithm implemented in the optimized tool path system.

FIG. 8 illustrates an example seventh embodiment of the algorithm implemented in the optimized tool path system.

FIG. 9 illustrates an example process associated with an embodiment of the optimized tool path system.

FIG. 10 illustrates an example block diagram of a cloud-based computing system operable to execute the disclosed systems and methods in accordance with this disclosure.

FIG. 11 illustrates an example block diagram of a computing system operable to execute the disclosed systems and methods in accordance with this disclosure.

### DETAILED DESCRIPTION

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

Numerous specific details are set forth in order to provide a thorough understanding of one or more embodiments of the described subject matter. It is to be appreciated, however, that such embodiments can be practiced without these specific details.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

A computer implemented method and system for optimizing single point manufacturing and additive manufacturing is disclosed. This includes 3D printing (planar, non-planar, multi directional), incremental sheet forming, and incremental formation CNC (3 or more axis) manufacturing. The method uses an optimized approach to place a non-intersecting Eulerian curve on a set of nodes that are constrained by a boundary curve. The method is intended to speed up the 3D printing process by eliminating the need for all travel moves within geometry boundaries.

The input matrix is partitioned into subsets and solves these subsets individually and then combines the solution.

A minimum spanning tree (MST) is created from dispatched nodes inside the shape outline. While creating an MST, the method enables the system to use input data with weights to give desired geometry properties. For example: this allows the creation of internal geometry to mimic texture of wood grain. This can be achieved through implementation to create strength in optimal direction or axis using said weights.

Alternatively, these weights can be allocated on a layer-by-layer basis, pertinent to the 3D printing context. Paths within the Minimum Spanning Tree (MST) that remain untraversed in a given layer will be subsequently assigned increased weight in the ensuing layer. Should a path remain unvisited over multiple iterations/layers, its weight will cumulatively amplify until it is eventually traversed. This iterative weight augmentation, termed “Smart Stacking” ensures enhanced internal structural integrity. This stems from increased junction overlap, thus optimizing the printed object's strength.

The method can be implemented for standard or non-standard repeating tiles, i.e. square nodes, triangular nodes (equilateral, isosceles, and scalent), hexagonal nodes, octagonal and rectangular nodes (trapezium, parallelogram, rectangle, rhombus, square, kite), and spiral nodes, etc. Repeating tiles can be overlapped to expand node pattern capabilities.

The method further allows a user to replace nodes with closed looped graphics, such as letters, logos, numbers, and patterns. This can be achieved by interlacing the disclosed algorithm with a subset algorithm solve.

The system can link input data to a serial number, which can be embedded with arbitrary meanings assigned by the user. These serial numbers are assigned to algorithm solves and linked to data or unique edition number. This is akin to the common practice in printmaking.

Through these instrumentalities, unique designs can be created with existing tools to optimize tool paths to save time. An algorithm can be implemented to remove self-intersections and unnecessary travel moves, which can result, in some embodiments, in a time savings of about 33% and in an increase of about 50% in speed for the process. In regard to 3D printing processes, which is a manner of single point manufacturing, the algorithm can be implemented to remove the need for all retractions within the input boundary by combining all moves, both speeding up printing and improving final quality in some embodiments.

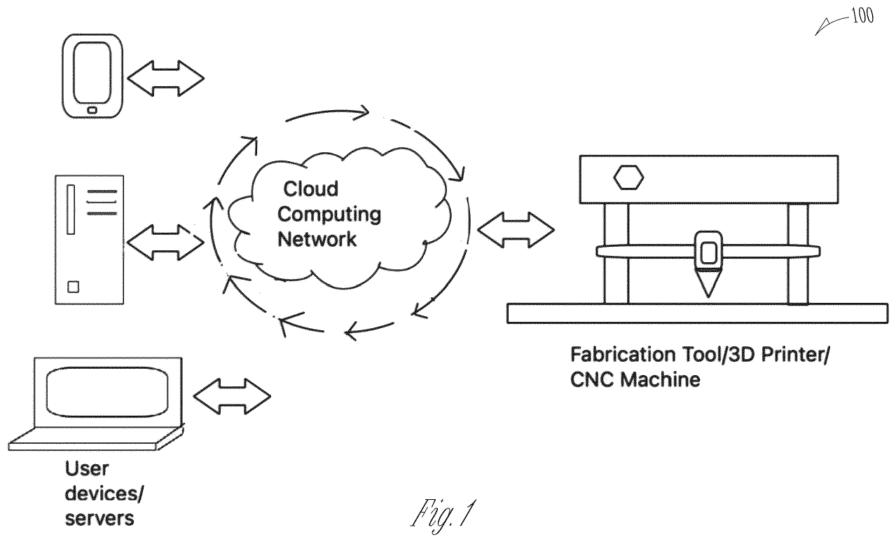

Referring to FIG. 1, an embodiment of a system 100 for optimizing a tool path algorithm is shown. In this figure, a manufacturing device is shown to be connected to a cloud computing network. The manufacturing device is a 3D printer in an embodiment. In other embodiments, the manufacturing device can be a CNC fabrication tool, metal fabrication tool, or other manufacturing tools that is capable of accepting computer implemented instructions. The cloud computing network is in turn connected to a number of user devices. In an embodiment, a user can access the optimized tool path algorithm through a personal computer. In other embodiments, the optimized tool path algorithm can be implemented in a local or remote server, or a portable personal computing device. It is envisioned that the optimized tool path algorithm can be implemented through a standalone computer-aided design (CAD) software, or be incorporated as an add-on to existing CAD software. Each of the user device should have an interface that would allow each user to interact with the optimized tool path algorithm through software that is normally associated with a desired manufacturing device.

The system considers the type of manufacturing device connected to the network, and produce programmed instructions as output for the optimized tool path algorithm. In function, the optimized tool path algorithm is tool agnostic. This allows the algorithm to be implemented with options for a variety of programmed instructions as output. As such, the algorithm produces an optimized tool path as part of programmed instructions, and the CAD software uses the output to control the respective manufacturing tool. The programmed instructions as output can be generated to be used by 3D printers, CNC fabrication tools, metal fabrication tools, etc. It is envisioned that the optimized tool path algorithm can be modified to generate output instructions that are better suited for the associated manufacturing tool. The output instructions will consider the manufacturing method, including singe point formatting, incremental sheet forming, and 3D printing or additive manufacturing.

The software associated with optimized tool path algorithm would adjust the output instructions in accordance with the specific demands of each manufacturing method. It is envisioned that the optimized tool path algorithm can be modified to work with the common additive manufacturing methods, such as vat photopolymerization, material jetting, binder jetting, powder bed fusion, material extrusion, directed energy deposition, and sheet lamination. A person with ordinary skills would be able to adapt the principle behind the optimized tool path algorithm to common methodologies associated with single point manufacturing and additive manufacturing.

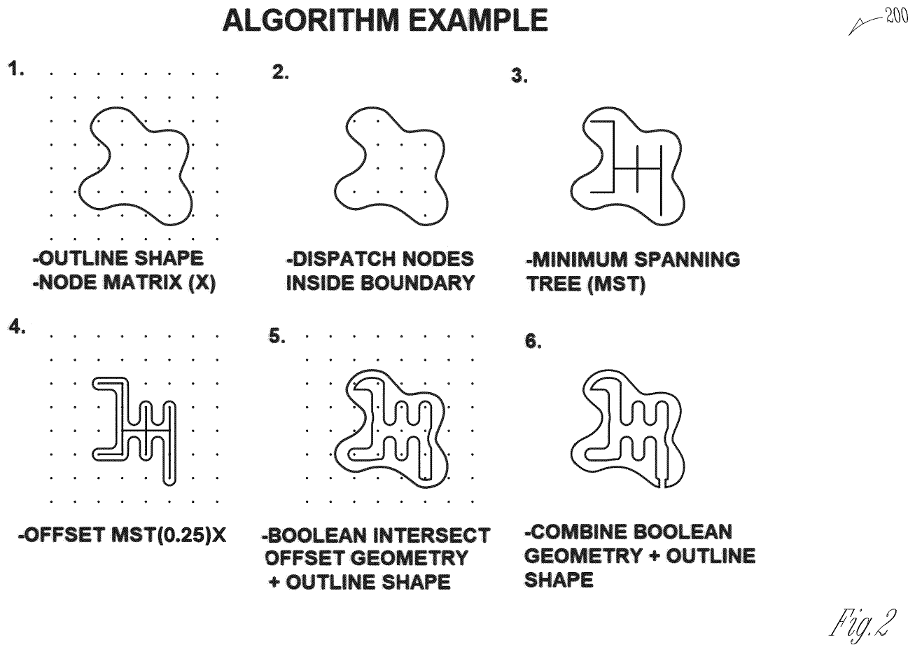

In FIG. 2, an example of the optimized tool path algorithm, generally designated by the numeral 200, is shown. In this figure, the process implemented by the algorithm to create the optimized tool path for manufacturing is broken into parts number 1-8. In part 1, an outline shape of the end product is provided to the system. This can be provided by a scan, an image file, or a CAD file compatible with the specific design program herein. Users can supply the outline shape file to the user device, which can process the file on the device or through a cloud computing network. The outline shape is then extracted from the user's input and overlaid onto a node matrix. The node matrix is used to calculate the optimize path in the subsequent steps.

In part 2, the node matrix is divided into the two sections, separated by the outline shape. As we are interested in creating a path for the product illustrated by the outline shape, the node matrix inside the outline shape is kept. Nodes are thus dispatched inside the boundary set forth by the outline shape.

In part 3, a minimum spanning tree (MST) is created on the node matrix in relation to the outline shape. The minimum weight spanning tree is analyzed and calculated to provide an outline for the tool path that would require the least amount of travel without overlap. The nature of the MST specifies that the sum of the edge weight would be the smallest in all possible spanning tree options, and thus would guide a tool path that would require the least amount of expenditure. In an embodiment, the system would employ any of the common computational methodologies that would be utilized to analyze minimum spanning trees. The system would also provide means for the users to input specific edge weight to give desired geometrical properties. For example, should the user want to emphasize the wood grain texture on a product, edge weight would be provided to alter the minimum spanning tree, such that the outcome would reflect the preferred texture.

In part 4, the optimized path tool algorithm applies a 0.25× offset to the minimum spanning tree. This generates an approximate boundary surrounding the minimum spanning tree, such that a singular path can be drawn to approximate the minimum spanning tree at the 0.25× offset. The path is stored as offset geometry, and will be used to guide the output tool path.

In part 5, the optimized tool path algorithm performs an Boolean operation on the offset geometry and the outline shape. In an embodiment, Boolean intersect is implemented on the offset geometry and the outline shape. The result of the Boolean intersect operation on the offset geometry and the outline shape produces a Boolean geometry.

Finally, in part 6, the optimized tool path algorithm combines the Boolean geometry with the outline shape to produce the optimized tool path. As shown in the part 6 of the figure, the resulting optimized tool path allows a closed loop path on which a fabrication tool can trace to produce the desired product. The process allows the associated fabrication tool to accurately produce a product physically based on a model. In the additive manufacturing or 3D printing field, this would allow the associated fabrication to generate the product with an efficient usage of the production material. In the CNC/incremental formation field, the resulting tool path would guide the fabrication tool to effectively produce a product without a die.

The process can be modified based on user preferences. In an embodiment, the user's inputs are partitioned into subsets and solve each partition in parallel. The optimized tool path algorithm would apply the appropriate methodology to solve each subset and combine the solutions at the end to a single face. The end result will be generated as an output for any of the additive manufacturing or single point manufacturing tools.

Depending on the requirement of specific applications, different offset geometries will be appropriate. The optimized tool path algorithm is implemented with the ability to apply various offset conditions in the process to produce the appropriate output tool path. In reference to FIG. 2, another embodiment of the optimized tool path algorithm is shown to incorporate footnote geometry in the analysis process. Similar to FIG. 1, the process is divided into 8 parts.

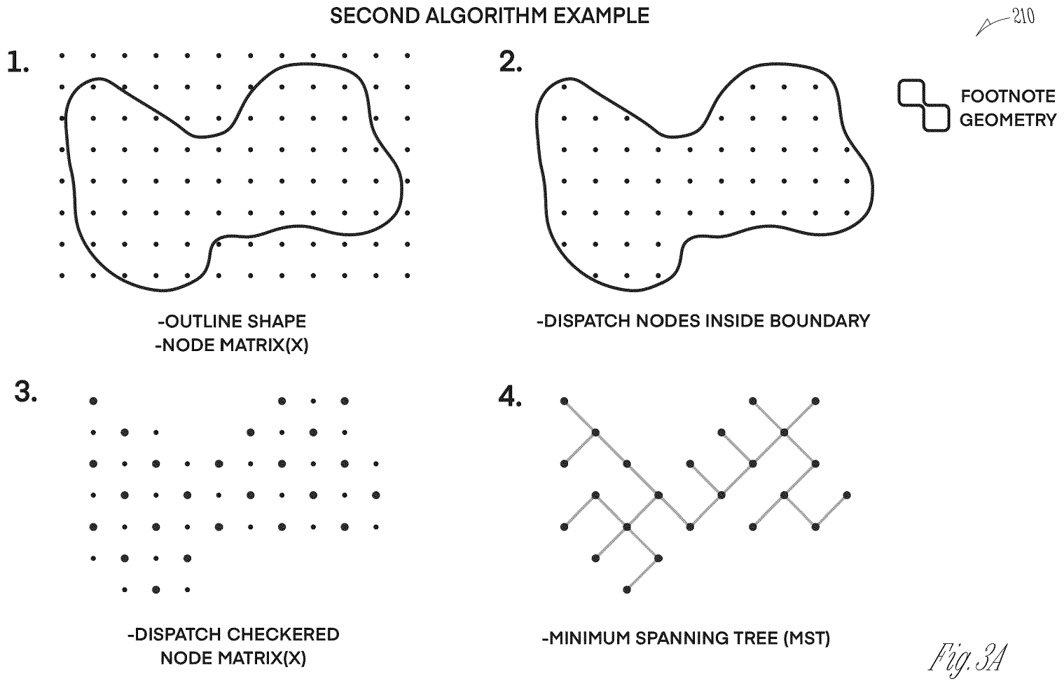

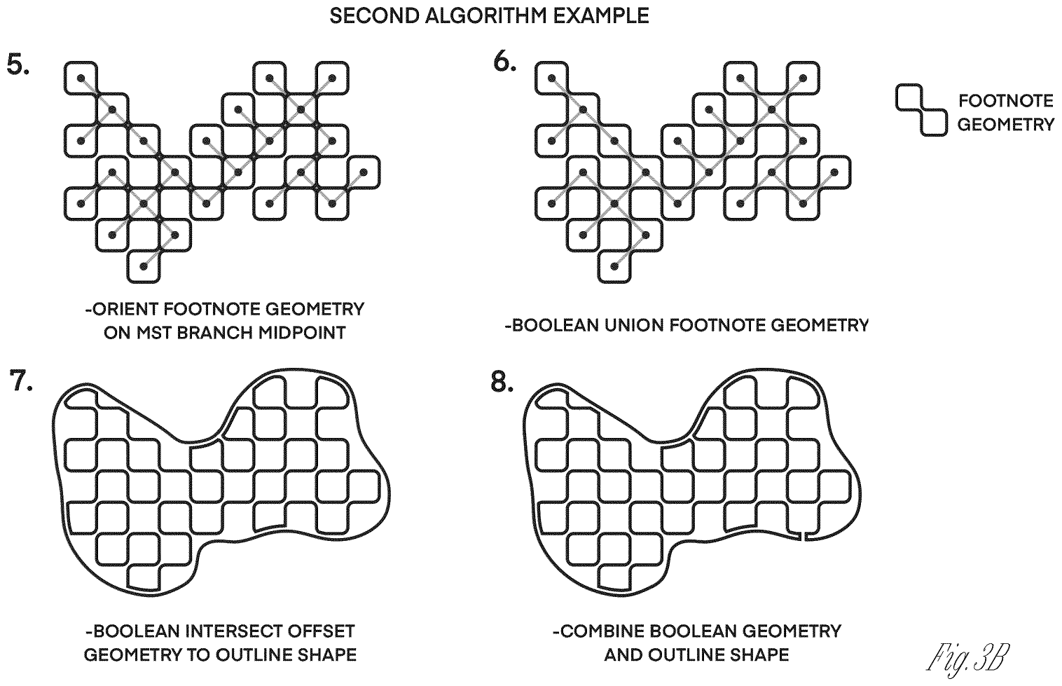

Refer to FIG. 3, In part 1, an outline shape is provided by the user as input to the system. This outline shape is overlaid onto a matrix node, such that a more detailed tool path can be analyzed and calculated. In part 2, the nodes are dispatched within the boundary of the outline shape.

As shown in part 3, a checkered node matrix is dispatched onto the resulting matrix node from part 2. In this embodiment, a varied version of the matrix nodes are implemented to accommodate the specific requirement of the product. In various embodiments, the types of matrix nodes and associated dispatch layouts can be utilized to emphasize the particular needs of each application. Some examples include square nodes, triangular nodes, hexagonal nodes, octagonal nodes, and spiral nodes. It is envisioned that users would be able to select and designate the specific node matrix according to the needs of the application.

In part 4, a minimum spanning tree (MST) is produced by the optimized tool path algorithm based on the checkered node. The MST in this embodiment considers the node pattern set forth by the user, and is analyzed through the designated checkered nodes on the node matrix. In part 5, the optimized tool path algorithm orients a footnote geometry onto the MST branch midpoints. The footnote geometry is utilized in this embodiment to accommodate the checkered node matrix, such that a more thorough tool path can be created.

In part 6, the optimized tool path algorithm implements a Boolean union between the footnote geometry and the MST. The Boolean operation is implemented with consideration with other input weights provided by the user. As stated in the embodiment in FIG. 1, various input weight can be provided by the user to emphasize particular effects on the end products.

In part 7, an additional Boolean operation is applied to the Boolean geometry from part 6. In this embodiment, a Boolean intersection is implemented between the offset geometry and the outline shape. The method utilizes the Boolean intersection to calculate and generate an appropriate tool path for the product.

Finally, the optimized tool path algorithm combines the Boolean geometry and the outline shape to generate a toolpath that would allow a fabricator tool to create the desired product through additive manufacturing and/or single point manufacturing means. The system would convert the tool path into an output tool path for the appropriate manufacturing tools. As shown in part 8, the combined utilization of the footnote geometry and the node matrix provides a more detailed tool path than some other embodiments. Functionally, this would be utilized when the user would place a particular texture or mesh emphasis on the product. Depending on the application, this process would improve the fabrication tool performance compared to traditional methods.

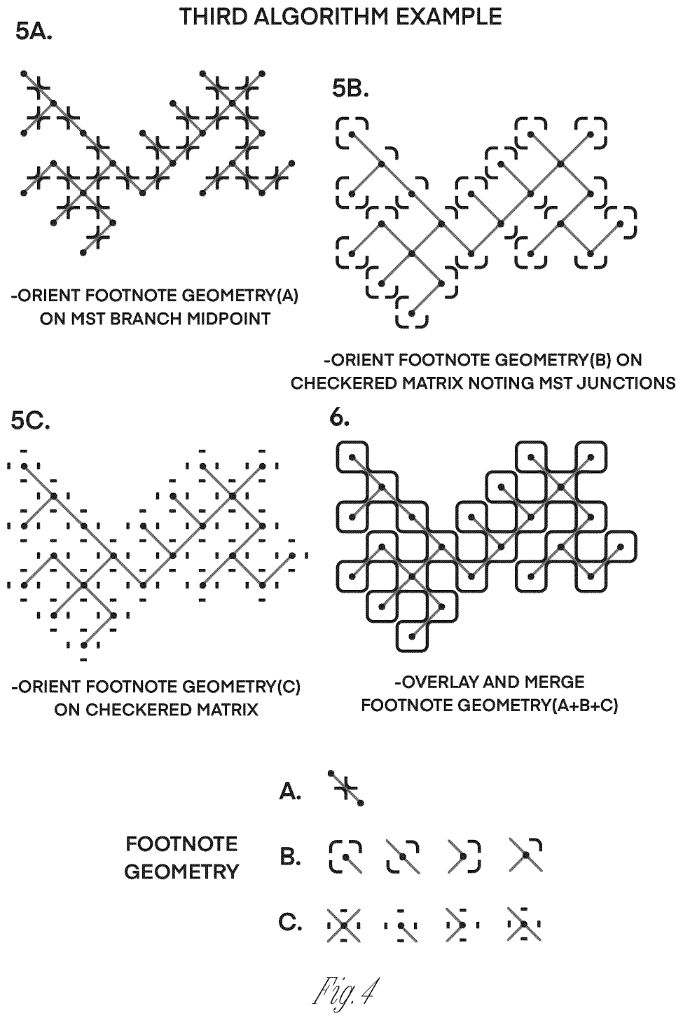

In FIG. 4, the third algorithm replaces steps 5 and 6 in the second algorithm 210 with steps 5A, 5B, 5C and 6 to achieve the same final results, These steps can potentially improve algorithm computational speed and give further flexibility.

In step 5A, the optimized tool path algorithm orients a footnote geometry(A) onto the MST branch midpoints.

In step 5B, the optimized tool path algorithm orients a footnote geometry(B) onto the checkered node matrix whilst noting the junction of the MST.

In part 5C, the optimized tool path algorithm orients a footnote geometry(C) onto the checkered node matrix .

In part 6, footnote geometry from steps 5A, 5B, and 5C are overlaid and merged. The merge operation is implemented with consideration with other input weights provided by the user. As stated in the embodiment in FIG. 1, various input weights can be provided by the user to emphasize particular effects on the end products.

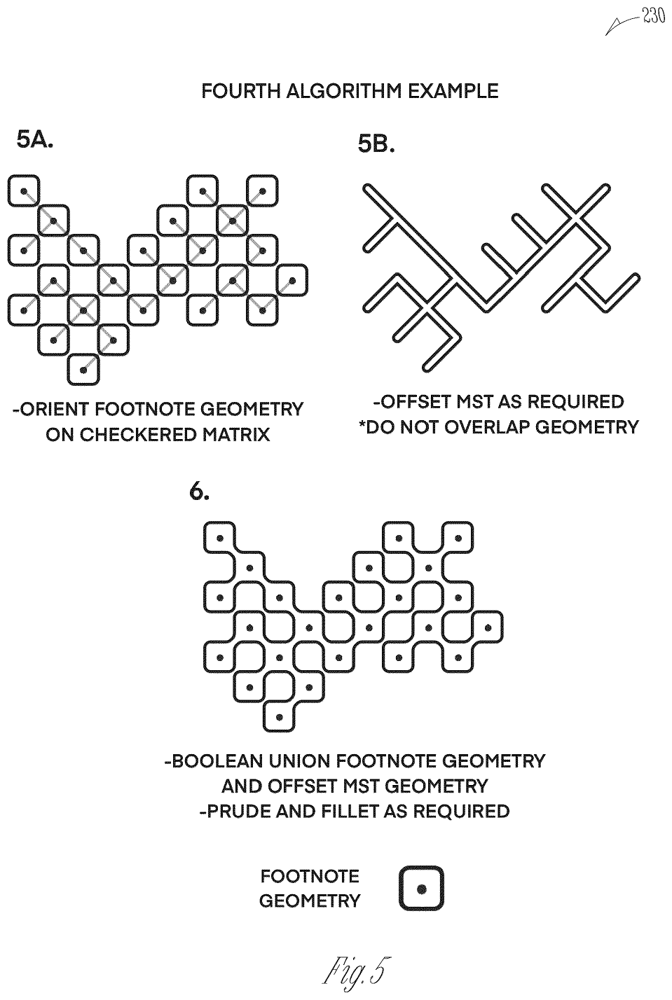

In FIG. 5, the fourth algorithm replaces steps 5 and 6 in the second algorithm with steps 5A, 5B, and 6 to achieve the same final results. These steps can potentially improve algorithm computational speed and give further flexibility.

In step 5A, the optimized tool path algorithm orients a footnote geometry (A) onto the checkered node matrix.

In step 5B, the MST is offset by a fraction of the spacing of an individual node from the input matrix to prevent geometric overlap.

In step 6, both geometries from steps 5A and 5B are overlaid to be Boolean unioned. Subsequently, the resulting geometry undergoes pruning and/or filleting as necessary. As stated in the embodiment in FIG. 1, various input weights can be provided by the user to emphasize particular effects on the end products.

Referring to FIG. 3, another embodiment of the optimized tool path algorithm, generally designated by the numeral 210, that is utilized by the system is shown. In certain situations, an outline shape is not available or not provided. The system provides a way to generate a toolpath without having to rely on such an outline shape.

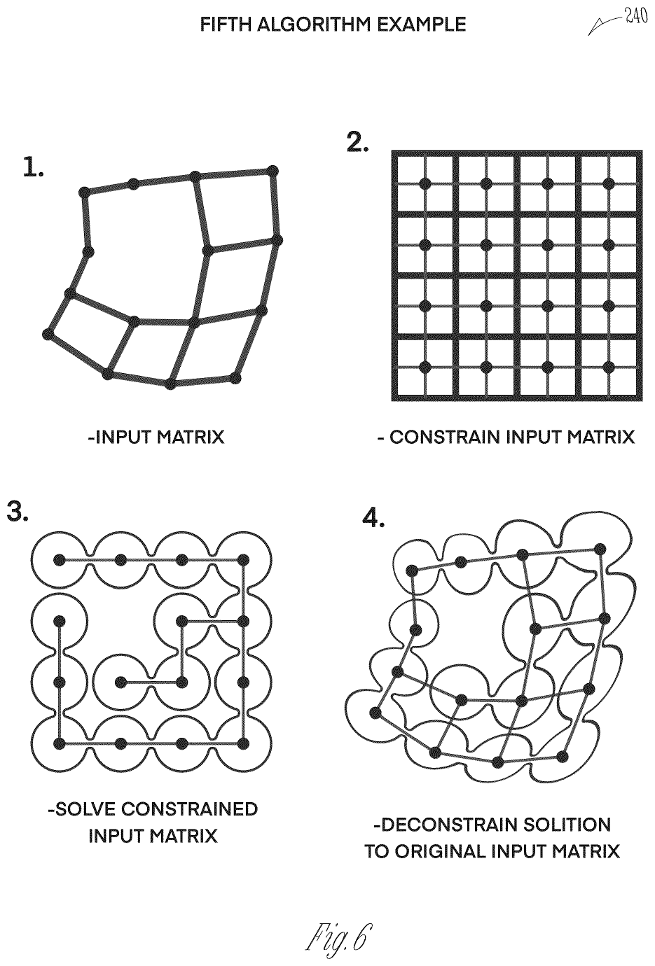

In part 1 of FIG. 6, a user provides an input matrix to the system, generally designated by the numeral 240. The input matrix provides an approximate guideline on the product to be produced. In part 2, a constraint input matrix is provided by the user to approximate the orientation of the input matrix. This places the input matrix node relation into a subset for the algorithm to solve. In part 3, the optimized tool path algorithm implements a process to solve the constrained input matrix. This process outlines the optimal tool path that would satisfy the constraints set forth in part 2 without requiring an outline shape to be provided. Finally, in part 4, the optimized tool path algorithm provides de-constrain solution to the original input matrix. The process thus enables the system to generate an appropriate output tool path to be implemented through the fabrication tool.

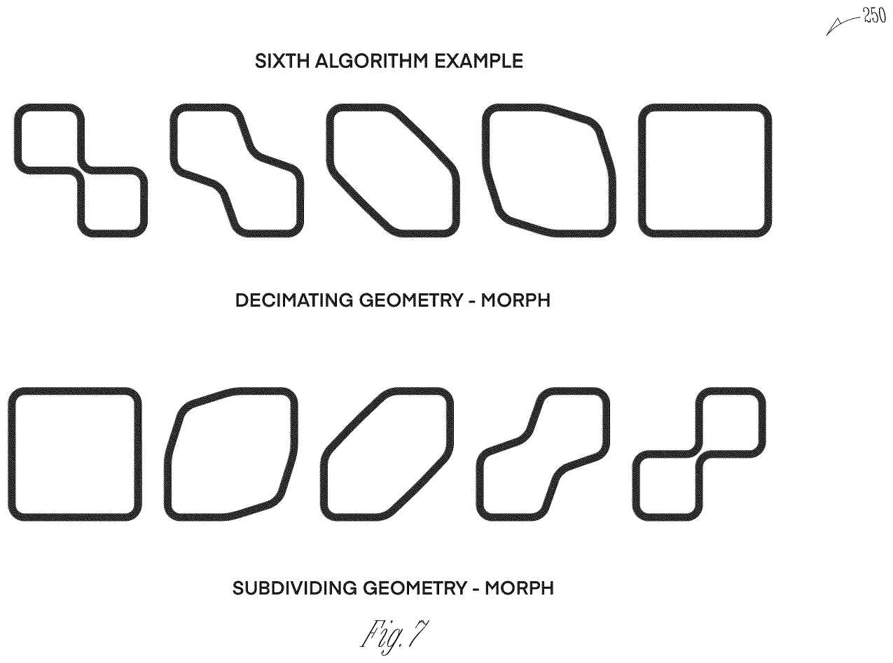

Referring to FIG. 7, the curve, once generated, possesses the capability to undergo progressive decimation or subdivision of the input matrix to optimize operational speed. As depicted in the accompanying figure, the transformation of the curve commences from its most rudimentary form, evolving gradually into a more intricate configuration. Such an approach offers a twofold advantage. Firstly, it reduces the requirement for thereby economizing material usage and print time. Secondly, as the geometry of the curve subdivides as layers progress, it facilitates the formation of the top surface with half bridge lengths, enhancing structural integrity and print fidelity. The process of subdividing can be repeated to minimize the bridging length even further

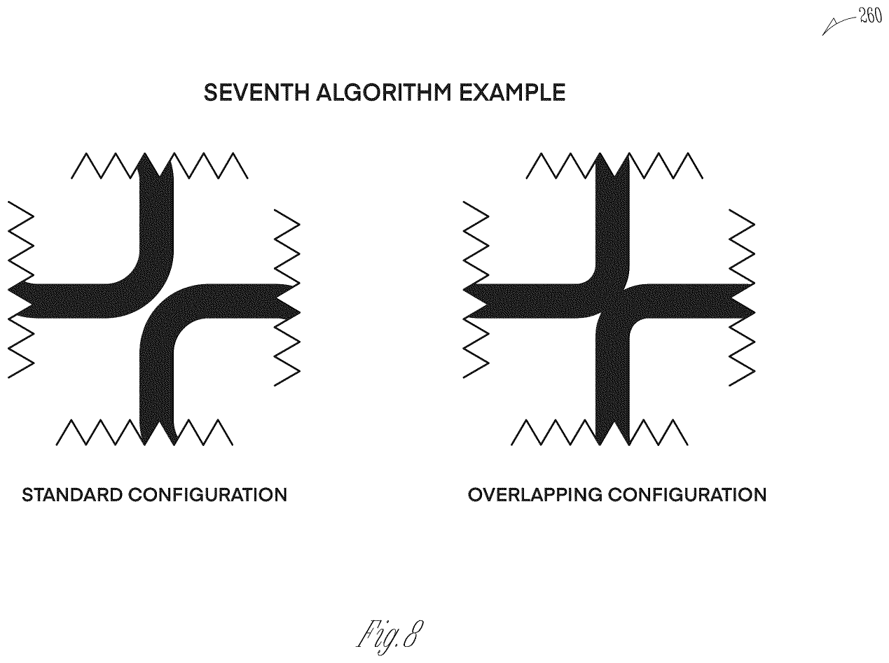

Referring to FIG. 8, the output geometry from said algorithm can undergo further deformations in either warping, offset, or modifying bevel amount to allow slight overlapping given the width of tool used of geometry to create junctional strength. In doing so, the part will achieve higher strength do to the greater amount of mechanical bounds nested inside of the part.

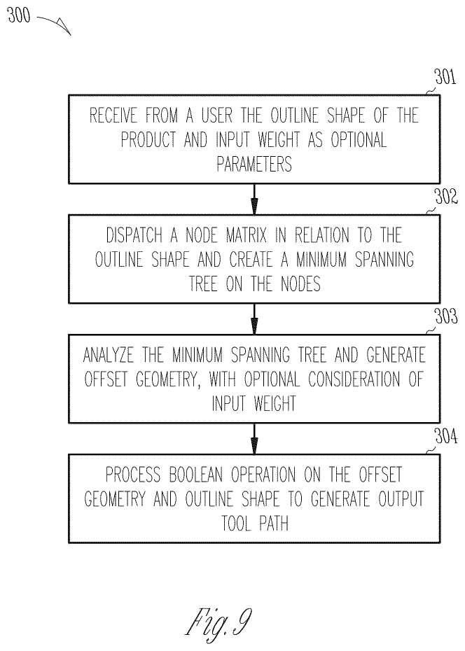

Refer to FIG. 9 for an embodiment of the process and method, generally designated by the numeral 300, that is implemented by the optimized tool path system. The method 300 can be implemented through any computer aided design system or a standalone design system. Overall, the method 300 takes primary product description input and optional parameters from a user, and processes the data through the various embodiments of the algorithm. The tool path is then generated as an output appropriate for the particular fabrication and manufacture machinery intended to carry out the production.

At Step 301, the method 300 begins with receiving from a user the outline shape of the product, as well as the input weight as optional parameters. It is envisioned that the user would have access to a personal computing device, laptop or desktop computers, tablet computers, or mobile phones with appropriate apps. Next, at Step 302, the method 300 dispatches a node matrix in relation to the outline shape. In one embodiment, the node matrix is overlayed with the outline shape such that the section within the boundary of the outline shape is further analyzed. The method 300 creates a minimum spanning tree on the nodes.

The minimum spanning tree can be further modified based on the input weight provided by the user. Such input weight would designate texture characteristics, in one embodiment. As such, the minimum spanning tree can be modified to instruct the fabrication tool to create a wood grain texture on the product, if intended, as an example.

Next, the method 300 utilizes one embodiment of the algorithm to analyze the minimum spanning tree and generate an offset geometry at Step 303. The offset geometry and the outline shape are then processed by the algorithm, wherein at least one Boolean operation can be carried out at Step 304. In an embodiment, Boolean intersection is performed on the offset geometry and outline shape, such that a tool path can be created in a mariner that optimizes tool performance. The output tool path can be further modified to be transferred to a variety of fabrication tools. The output tool path can be utilized by manufacturing tools in either single point manufacturing or additive manufacturing field. In some embodiments, one output tool path can be converted into multiple output instructions for a variety of fabrication tools.

The system and method is intended to be used by 3D printing machines, CNC fabrication tools, incremental formation tools, etc. It is envisioned that the optimized tool path can be utilized in any state of the art manufacturing methodology at the time.

The system encompasses the ability to allow a design program to replace nodes in the aforementioned node matrices with closed looped graphics. Such graphics can include letters, logos numbers, and patterns. The method would interlace with a subset algorithm solve to further incorporate these closed looped graphics in an output instruction.

The system encompasses the ability to link input data with a serial number, such that each particular solve or output tool path can be embedded with arbitrary meaning. Thus, each solve can be linked to external data such as date, edition number, signature logos, and other such markers as seen in printmaking processes.

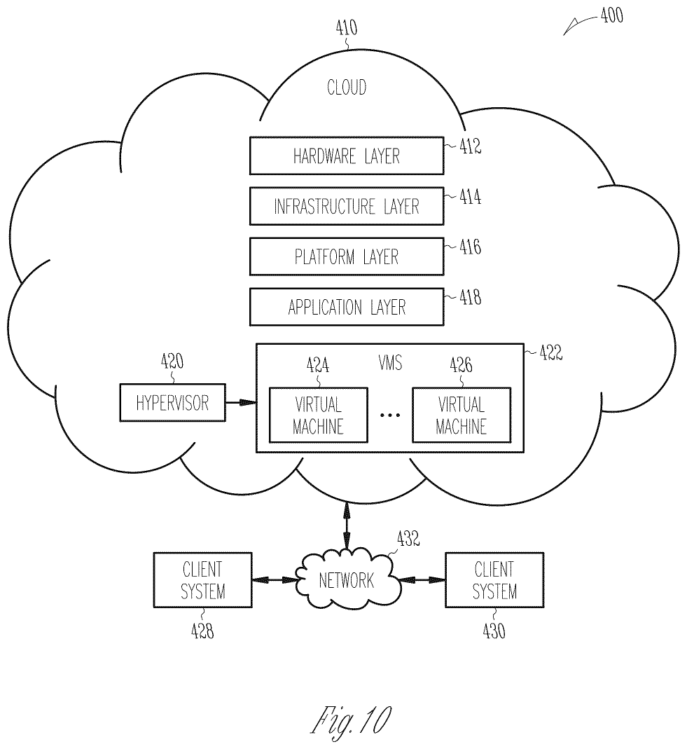

Referring to FIG. 10 with continuing reference to the foregoing figures, an exemplary cloud architecture, generally designated by the numeral 400, is provided for implementing the system shown in FIGS. 1-8 and the method shown in FIG. 9. The exemplary cloud architecture 400 provides computation, software, data access, and storage services that do not require end-user knowledge of the physical location or configuration of the system that delivers the services. In various embodiments, cloud computing delivers the services over a wide area network, such as the internet, using appropriate protocols.

For instance, cloud computing providers deliver applications over a wide area network and they can be accessed through a web browser or any other computing component. Software or components of architecture 400 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud can be managed by the organization itself and the infrastructure is typically not shared with other organizations. The organization still maintains the hardware to sonic extent, such as installations and repairs, etc.

As shown in FIG. 10, the cloud architecture 400 includes a cloud 410. The cloud 410 (or each of the different premises on the cloud 410) can include a hardware layer 412, an infrastructure layer 414, a platform layer 416, and an application layer 418.

A hypervisor 420 can illustratively manage or supervise a set of virtual machines 422 that can include a plurality of different, independent, virtual machines 424-426. Each virtual machine can illustratively be an isolated software container that has an operating system and an application inside it. It is illustratively decoupled from its host server by hypervisor 420. In addition, hypervisor 420 can spin up additional virtual machines or close virtual machines, based upon workload or other processing criteria.

A plurality of different client systems 428-430 (which can be end user systems or administrator systems, or both) can illustratively access cloud 410 over a network 432. Depending upon the type of service being used by each of the client systems 428-430, cloud 410 can provide different levels of service. In one example, the users of the client systems are provided access to application software and databases. The cloud service then manages the infrastructure and platforms that run the application. This can be referred to as software as a service (or SaaS). The software providers operate application software in application layer 418 and end users access the software through the different client systems 428-430.

The cloud provider can also use platform layer 416 to provide a platform as a service (PaaS). This involves an operating system, programming language execution environment, database and webserver being provided to the client systems 428-430, as a service, from the cloud provider. Application developers then normally develop and run software applications on that cloud platform and the cloud provider manages the underlying hardware and infrastructure and software layers.

The cloud provider can also use infrastructure layer 414 to provide infrastructure as a service (IaaS). In such a service, physical or virtual machines and other resources are provided by the cloud provider, as a service. These resources are provided, on-demand, by the IaaS cloud provider, from large pools installed in data centers. In order to deploy the applications, the cloud users that use IaaS install operating-system images and application software on the cloud infrastructure 400.

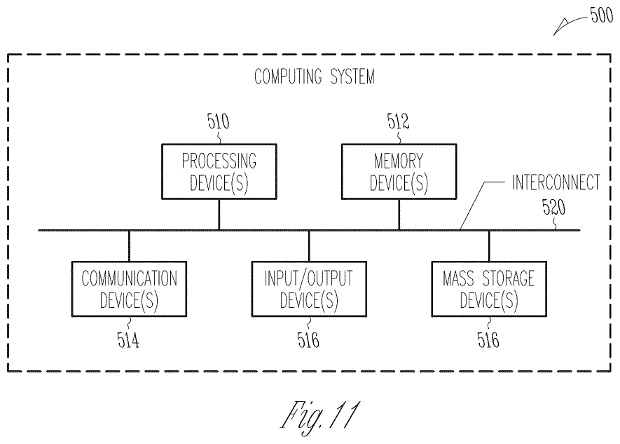

Referring now to FIG. 11 with continuing reference to the forgoing figures, a computer system for implementing an exemplary computing system, generally designated by the numeral 500, is provided for use by the system shown in FIGS. 1-8 and/or to implement the method shown in FIG. 9.

The hardware architecture of the computing system 500 that can be used to implement any one or more of the functional components described herein. In some embodiments, one or multiple instances of the computing system 500 can be used to implement the techniques described herein, where multiple such instances can be coupled to each other via one or more networks.

The illustrated computing system 500 includes one or more processing devices 510, one or more memory devices 512, one or more communication devices 514, one or more input/output (I/O) devices 516, and one or more mass storage devices 518, all coupled to each other through an interconnect 520. The interconnect 520 can be or include one or more conductive traces, buses, point-to-point connections, controllers, adapters, and/or other conventional connection devices. Each of the processing devices 510 controls, at least in part, the overall operation of the processing of the computing system 500 and can be or include, for example, one or more general-purpose programmable microprocessors, digital signal processors (DSPs), mobile application processors, microcontrollers, application-specific integrated circuits (ASICs), programmable gate arrays (PGAs), or the like, or a combination of such devices.

Each of the memory devices 512 can be or include one or more physical storage devices, which can be in the form of random-access memory (RAM), read-only memory (ROM) (which can be erasable and programmable), flash memory, miniature hard disk drive, or other suitable type of storage device, or a combination of such devices. Each mass storage device 518 can be or include one or more hard drives, digital versatile disks (DVDs), flash memories, or the like. Each memory device 512 and/or mass storage device 518 can store (individually or collectively) data and instructions that configure the processing device(s) 510 to execute operations to implement the techniques described above.

Each communication device 514 can be or include, for example, an Ethernet adapter, cable modem, Wi-Fi adapter, cellular transceiver, baseband processor, Bluetooth or Bluetooth Low Energy (BLE) transceiver, serial communication device, or the like, or a combination thereof. Depending on the specific nature and purpose of the processing devices 510, each I/O device 516 can be or include a device such as a display (which can be a touch screen display), audio speaker, keyboard, mouse or other pointing device, microphone, camera, etc. Note, however, that such I/O devices 516 can be unnecessary if the processing device 510 is embodied solely as a server computer.

In the case of a client device, the communication devices(s) 514 can be or include, for example, a cellular telecommunications transceiver (e.g., 3G, LTE/4G, 5G), Wi-Fi transceiver, baseband processor, Bluetooth or BLE transceiver, or the like, or a combination thereof. In the case of a server, the communication device(s) 514 can be or include, for example, any of the aforementioned types of communication devices, a wired Ethernet adapter, cable modem, DSL modem, or the like, or a combination of such devices.

A software program or algorithm, When referred to as “implemented in a computer-readable storage medium,” includes computer-readable instructions stored in a memory device (e.g., memory device(s) 512). A processor (e.g., processing device(s) 510) is “configured to execute a software program” when at least one value associated with the software program is stored in a register that is readable by the processor. In some embodiments, routines executed to implement the disclosed techniques can be implemented as part of OS software (e.g., MICROSOFT WINDOWS® and LINUX®) or a specific software application, algorithm component, program, object, module, or sequence of instructions referred to as “computer programs.”

Computer programs typically comprise one or more instructions set at various times in various memory devices of a computing device, which, when read and executed by at least one processor (e.g., processing device(s) 510), will cause a computing device to execute functions involving the disclosed techniques. In some embodiments, a carrier containing the aforementioned computer program product is provided. The carrier is one of an electronic signal, an optical signal, a radio signal, or a non-transitory computer-readable storage medium (e.g., the memory device(s) 512).

A proposed theoretical methodology enables systematic collection of user/client outputs from the stated algorithms from above that generates non-intersecting Eulerian curves. These outputs can be archived in cloud storage, computer databases, or other pertinent digital storage mediums, forming a foundational dataset encompassing a broad spectrum of path planning scenarios and their resolutions.

Each dataset entry may be tagged, categorized, or labeled according to essential parameters, which might include factors such as input weights, path length, design complexity, print duration, vector changes count, strength directionality, among other pertinent metrics. This meticulously labeled dataset is primed for utilization in both supervised and unsupervised machine learning paradigms.

The dataset is channeled to an AI system for training on suitable computational infrastructure. Through iterative learning cycles, the AI mines for patterns, delineates correlations, and homes in on optimal methodologies. Post each learning epoch, a validation subsystem scrutinizes the AI's outputs against a set benchmark. Any deviation from this benchmark instigates recalibration of the model's parameters, prompting another round of training. This validation benchmark begins at a rudimentary level, advancing in intricacy in tandem with the model's evolution towards sophisticated outcomes.

Once adequately trained, the AI system can employ its acquired expertise to craft more intricate and efficient 3D printing trajectories, outpacing conventional methodologies alongside the stated algorithms above. This symbiotic relationship between the foundational algorithms and the AI augments 3D printing technology capabilities, optimizing print quality, minimizing waste, and bolstering efficiency.

With the advent of new data from varied 3D printing assignments, periodic database updates can be initiated. This consistent data influx fortifies the AI system's relevancy, equipping it to navigate the ever-evolving intricacies of 3D printing path planning.

As advancements in AI materialize, they can be seamlessly integrated to perpetually enhance system proficiency. In some examples, a specified geometry output, from which a repeating degree logic is utilized, presents a distinct and previously undescribed form of a non-intersecting Eulerian curve. This uniqueness remains intact, even when accommodating alterations from a defined outline.

Thus in some examples, there is provided a system for optimizing tool path in manufacturing, the system comprising: a user device configured to receive input data from at least one user, wherein the input data comprises at least one shape outline and one input weight; a computer enabled manufacturing tool configured to receive instructions; and a cloud computing network configured with an algorithm to dispatch at least one node matrix in relation to the at least one shape outline, generate an offset geometry from at least one dispatched node inside the at least one shape outline, and generate an optimized tool path through at least one Boolean operation based on the offset geometry and input weight, and to convert the optimized tool path into at least one output instruction for a manufacturing tool.

In some examples, the input weight enables the cloud computing network to create texture outputs as part of the at least one output instruction. In some examples, the offset geometry is created based on a minimum spanning tree, generated by the algorithm from the at least one dispatched node inside the at least one shape outline. In some examples, the algorithm replaces the at least one dispatched node with closed looped graphics. In some examples, the at least one output instruction is sent to a fabrication tool utilizing a single point manufacturing methodology. In some examples, the at least one output instruction is sent to a fabrication tool utilizing an additive manufacturing methodology. In some examples, the cloud computing network is further configured to optimize the tool path by removing unnecessary motions and backtracking. In some examples, the cloud computing network is further configured to accept and process input shapes without a defined outline. In some examples, the node matrix comprises at least one of: square nodes, triangular nodes, hexagonal nodes, octagonal nodes, spiral nodes. In some examples, the cloud computing network is further configured to iteratively augment weights of unvisited paths across multiple iterations or layers to ensure traversal.

In some examples, there is provided a method for optimizing a tool path in manufacturing, the method comprising: receiving user input on a user device, wherein the user input comprises at least one outline shape and at least one input weight; dispatching at least one node matrix inside the at least one outline shape; creating an offset geometry from at least one dispatched node inside the at least one outline shape; processing at least one Boolean operation on the at least one dispatched node in relation to the at least one outline shape to generate a Boolean geometry; generating an optimized tool path from the Boolean geometry; and converting the optimized tool path to at least one output instruction for a fabrication tool.

In some examples, the method further comprises creating internal geometry based on the at least one input weight to create texture output. In some examples, the at least one output instruction is used in an additive manufacturing methodology. In some examples, the at least one output instruction is used in a single point manufacturing methodology. In some examples, a junction geometry is adjusted to allow an overlap to increase internal strength. In some examples, the at least one output instruction is stored in a database to train an AI model. In some examples, the method is applied in a three-dimensional space.

In some examples, a geometry output comprises a single line pattern governed by a repeating node degree logic, wherein every path of an associated graph based on the repeating node degree logic is traversed once and without intersection; wherein interruptions may occur in the repeating node degree logic in response to an external shape outline; and wherein a uniqueness in pattern is derived specifically from the use of the repeating degree logic.

In some examples, a product comprises, or is based on, at least one geometry output as summarized above, or is made by a system as summarized above, or is made by or based on any one or more of the method operations summarized above.

The detailed description provided above in connection with the appended drawings is intended as a description of examples and is not intended to represent the only forms in which the present examples can be constructed or utilized. It is to be understood that the configurations and/or approaches described herein are exemplary in nature, and that the described embodiments, implementations and/or examples are not to be considered in a limiting sense, because numerous variations are possible. The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is:

1. A system for optimizing tool path in manufacturing, the system comprising:
a user device configured to receive input data from at least one user, wherein the input data comprises at least one shape outline and one input weight;
a computer enabled manufacturing tool configured to receive instructions; and
a cloud computing network configured with an algorithm to dispatch at least one node matrix in relation to the at least one shape outline, generate an offset geometry from at least one dispatched node inside the at least one shape outline, and generate an optimized tool path through at least one Boolean operation based on the offset geometry and input weight, and to convert the optimized tool path into at least one output instruction for a manufacturing tool.

2. The system of claim 1, wherein the input weight enables the cloud computing network to create texture outputs as part of the at least one output instruction.

3. The system of claim 1, wherein the offset geometry is created based on a minimum spanning tree, generated by the algorithm from the at least one dispatched node inside the at least one shape outline.

4. The system of claim 1, wherein the algorithm replaces the at least one dispatched node with closed looped graphics.

5. The system of claim 1, wherein the at least one output instruction is sent to a fabrication tool utilizing a single point manufacturing methodology.

6. The system of claim 1, wherein the at least one output instruction is sent to a fabrication tool utilizing an additive manufacturing methodology.

7. The system of claim 1, wherein the cloud computing network is further configured to optimize the tool path by removing unnecessary motions and backtracking.

8. The system of claim 1, wherein the cloud computing network is further configured to accept and process input shapes without a defined outline

9. The system of claim 1, wherein the at least one node matrix comprises at least one of: square nodes, triangular nodes, hexagonal nodes, octagonal nodes, spiral nodes.

10, The system of claim 1, wherein the cloud computing network is further configured to iteratively augment weights of unvisited paths across multiple iterations or layers to ensure traversal.

11. A method for optimizing a tool path in manufacturing, the method comprising:
receiving user input on a user device, wherein the user input comprises at least one outline shape and at least one input weight;
dispatching at least one node matrix inside the at least one outline shape;
creating an offset geometry from at least one dispatched node inside the at least one outline shape;
processing at least one Boolean operation on the at least one dispatched node in relation to the at least one outline shape to generate a Boolean geometry;
generating an optimized tool path from the Boolean geometry; and
converting the optimized tool path to at least one output instruction for a fabrication tool.

12. The method of claim 11, further comprising creating internal geometry based on the at least one input weight to create texture output.

13. The method of claim 11, wherein the at least one output instruction is used in an additive manufacturing methodology.

14. The method of claim 11, wherein the at least one output instruction is used in a single point manufacturing methodology.

15. The method of claim 11, wherein a junction geometry is adjusted to allow an overlap to increase internal strength.

16. The method of claim 11, wherein the at least one output instruction is stored in a database to train an AI model.

17. The method of claim 11, wherein the method is applied in a three-dimensional space.

18. The method of claim 11, further comprising optimizing the tool path by removing unnecessary motions and backtracking.

19. The method of claim 11, further comprising accepting and processing input shapes without a defined outline.

20. The method of claim 11, wherein the at least one node matrix comprises at least one of: square nodes, triangular nodes, hexagonal nodes, octagonal nodes, spiral nodes.

21. A geometry output, comprising:
a single line pattern governed by a repeating node degree logic, wherein every path of an associated graph based on the repeating node degree logic is traversed once and without intersection;
wherein interruptions may occur in the repeating node degree logic in response to an external shape outline; and
wherein a uniqueness in pattern is derived specifically from the use of the repeating degree logic.

22. A product comprising, or based on, at least one geometry output according to claim 21.
